(19) United States
(12) Patent Application Publication
(10) Pub. No.: US 2009/0234707 A1
(43) Pub. Date: Sep. 17, 2009

(54) Method and system for providing designer templates within a print order system

(76) Inventors: John Perez, Redmond, WA (US); Traci Pichette, Lake Forest Park, WA (US)

Correspondence Address: Soquel Group, LLC, P.O. Box 691, Soquel, CA, 95073, US

(21) Appl. No.: 12/075,996

(22) Filed: Mar. 14, 2008

(51) Int. Cl. G06Q 30/00

(52) U.S. Cl. 705/10; 705/14; 705/39

(57) ABSTRACT

A method for providing designer templates to a customer, comprising providing a designer interface for receiving a designer template for a print product from a designer wherein a designer template comprises fixed content elements and at least one variable content element, and providing a customer interface for enabling a customer to select a print product and to select a designer template for the selected print product, enabling the customer to customize the selected print product by supplying his own content for the at least one variable content element of the selected designer template, and enabling the customer to purchase the custom print product that he customized.

### FIELD OF THE INVENTION

The present invention relates to a method and system that enables designers to provide templates that enable customers to create custom print products by customizing the templates.

### BACKGROUND OF THE INVENTION

Popular web sites now enable retail customers to create and order a variety of custom print products, including inter alia calendars, greetings cards, notepads, and photo books. Retail customers insert their own text and photos within templates provided on the web sites and in retail stores. Such web sites include www.snapfish.com operated by Hewlett-Packard Company of Palo Alto, Calif., www.shutterfly.com operated by Shutterfly, Inc. of Redwood City, Calif. and www.blurb.com operated by Blurb, Inc. of San Francisco, Calif. Such retailers include Walmart and Walgreens. In some cases, print fulfillers print the resulting photo products.

Orders for custom print products typically involve low quantities. Often customers order only a single copy of a book or calendar. Custom print products are customized by the customer. Typically the web site or retail store, henceforth referred to as a “print order system”, supplies one or more pre-designed, customizable, templates for each print product. Such templates are also referred to as “designer templates” or simply templates. The retail customer, henceforth referred to simply as a “customer”, modifies a template to create a custom print product by inter alia supplying his/her own digital photographs, graphical elements, text, and music or by selecting images, text, graphical elements, and music from lists provided by the print order system. It should be noted that digital photographs, which are commonly referred to as photos, or digital images are henceforth referred to simply as images.

Templates are an important component supplied by the print order system. Templates are provided for most common types of consumer printed products including inter alia calendars, greetings cards, notepads, mugs, and photo books. Templates reflect events such as birthdays and anniversaries, holidays such as Christmas, Hanukkah, and Valentine's Day, and family activities such as vacations and sporting events and team sports. In addition to price and quality, the diversity of and attractiveness of templates are important criteria used by customers when selecting which print order system to use.

Typically, templates are designed by inter alia hobbyists, professional artists or professional graphic designers, henceforth referred to simply as “designers”.

The present invention teaches the ability to increase diversity and selection of templates by enabling designers that are independent of a print order system to provide templates. Typically, said designers would receive some form of payment for providing templates such as a share of the revenue obtained by the print order system for custom print products that use the designers' templates.

As the quantity and diversity offered by a print order system increases, it is important that customers be able to quickly and easily locate desirable templates. The present invention makes use of customer ratings, recommendations, as well as enhanced searching and browsing capabilities to accomplish this.

Such a system can be referred to as a “template marketplace” because it makes it possible for designers not employed by or contracted by the print order system to supply templates using a designer interface. Prior art systems do not teach a template marketplace nor a designer interface for providing templates in the same way that the present invention does.

### SUMMARY OF THE DESCRIPTION

The present invention concerns online creation of custom print products that are subsequently ordered, and printed or fulfilled. It may be noted that the steps of receiving an order that includes one or more custom print products, printing, binding and packaging the custom print products and finally delivering or causing delivery of the custom print products is referred to herein as “fulfilling” or “fulfillment”. One method for creating a custom print product is for a customer to supply his/her own content for inclusion in a pre-designed template. The template includes fixed content elements that cannot be customized and variable content elements that can be customized, i.e. supplied or modified, by the customer. Aspects of the invention provide systems and methods for a print ordering system to enable a designer to provide templates that are made available to customers for browsing and selection where the templates enable a customer to interactively create a custom print product which the customer can then purchase. Typically, the print order system will pay the designer a portion of the fees that it collects from customers for custom print products that use the designer's templates.

The print order system enables customers to rate templates and see one or more statistics based on customer ratings. The print order system further provides recommendations about templates to customers.

The print order system enables the customer to interactively customize one or more templates thereby creating one or more custom print products. The customer may then purchase the custom print products. Typically, online purchasing involves a shopping cart mechanism wherein the customer supplies information such as inter alia the customer name, method of payment, quantity of each product ordered, and recipient contact data. The print order system then generates an order and sends the order to the print fulfillment system which fulfills the order and ships it to the recipient(s). In some cases the same organization provides both the print order system and print fulfillment system. In other cases, the print order system is one organization which has contractual relationships with one or more organizations that provide print fulfillment systems.

There is thus provided in accordance with an embodiment of the present invention a method for providing designer templates to a customer, comprising providing a designer interface for receiving a designer template for a print product from a designer wherein a designer template comprises fixed content elements and at least one variable content element, and providing a customer interface for enabling a customer to select a print product and to select a designer template for the selected print product, enabling the customer to customize the selected print product by supplying his own content for the at least one variable content element of the selected designer template, and enabling the customer to purchase the custom print product that he customized.

There is additionally provided in accordance with an embodiment of the present invention a system for providing designer templates to a customer, comprising a designer interface for receiving a designer template for a print product from a designer wherein a designer template comprises fixed content elements and at least one variable content element, and a customer interface for enabling a customer to select a print product and to select a designer template for the selected print product, enabling the customer to customize the selected print product by supplying his own content for the at least one variable content element of the selected designer template, and enabling the customer to purchase the custom print product that he customized.

There is moreover provided in accordance with an embodiment of the present invention a computer-readable storage medium storing program code for causing a computing device to receive a designer template for a print product from a designer wherein a designer template comprises fixed content elements and at least one variable content element, to enable a customer to select a print product and to select a designer template for the selected print product, to enable the customer to customize the selected print product by supplying his own content for the at least one variable content element of the selected designer template, and to enable the customer to purchase the custom print product that he customized.

There is further provided in accordance with an embodiment of the present invention a method for providing templates to a customer, comprising providing a designer interface for receiving a designer template for a print product from a designer wherein a designer template comprises fixed content elements and at least one variable content element, providing a customer interface for enabling a customer to select a print product and to select a designer template for the selected print product, enabling the customer to customize the selected print product by supplying his own content for the at least one variable content element of the selected designer template, and enabling the customer to purchase the custom print product that he customized, and providing an electronic payment, the amount of which is based on purchases by customers of print products that use a designer's designer templates, to an account designated by the designer.

There is yet further provided in accordance with an embodiment of the present invention a system for providing templates to a customer, comprising a designer interface for receiving a designer template for a print product from a designer wherein a designer template comprises fixed content elements and at least one variable content element, a customer interface for enabling a customer to select a print product and to select a designer template for the selected print product, enabling the customer to customize the selected print product by supplying his own content for the at least one variable content element of the selected designer template, and enabling the customer to purchase the custom print product that he customized, and a payment manager for providing an electronic payment, the amount of which is based on purchases by customers of print products that use the designer's designer templates, to an account designated by the designer.

### BRIEF DESCRIPTION OF THE DRAWINGS

The subject invention will be more fully understood and appreciated from the following detailed description, taken in conjunction with the drawings in which:

FIG. 1 is an exemplary customer interface used by a customer to create a calendar, in accordance with an embodiment of the subject invention;

FIG. 2 is a simplified block diagram of a system that accepts templates from designers, enables customers to create custom print products using said templates and purchase the custom print products, generate orders and provide said order to a print fulfillment system that fulfills the orders, in accordance with an embodiment of the subject invention;

FIG. 3 is an exemplary customer interface that illustrates how a customer may browse and search for, rate and select a template for use in creating a custom print product, in accordance with an embodiment of the subject invention;

FIG. 4 is an exemplary customer interface that illustrates how a customer may use a template provided by a designer to create a photo book, in accordance with an embodiment of the subject invention;

FIG. 5 is an exemplary designer interface used by a designer to upload the elements for a template, in accordance with an embodiment of the subject invention;

FIG. 6 is an exemplary designer interface used by a designer to select the price of a template, in accordance with an embodiment of the subject invention;

FIG. 7 is an exemplary designer interface used by a designer to interactively design a template, in accordance with an embodiment of the subject invention;

FIG. 8 is a depiction of a greeting card with four surfaces, in accordance with an embodiment of the subject invention;

FIG. 9 is a schematic description of a simplified order of a photo book, in accordance with an embodiment of the subject invention;

FIG. 10 is a simplified block diagram of a print order system, in accordance with an embodiment of the subject invention;

FIG. 11 is a simplified flowchart of an overall method that accepts templates from designers, enables customers to create custom print products using said templates and purchase the custom print products, generate orders and provide said orders to a print fulfillment system that fulfills the orders, in accordance with an embodiment of the present invention; and

FIG. 12 is a simplified block diagram of a sample server-client architecture for implementing a print order system, in accordance with an embodiment of the present invention.

### DETAILED DESCRIPTION

The present invention concerns a print order system that accepts templates from template designers, enables customers to create custom print products using the templates and purchase the custom print products, generate orders and provide said orders to a print fulfillment system that fulfills the orders. In addition, the print order system may pay the designer for templates that he/she supplies. The print order system can be inter alia a web-based system, a client-server system that operates over the public Internet or another network, or a retail store. The print order system is operated by a print order system operator which is typically a company or other organization.

In the present invention, a template defines a pre-designed print product that may be customized by a customer to create a custom print product. A template may include inter alia front and back pages, interior pages, and separator pages where any such page may be “printable”, i.e. may be printed upon. Each printable page may include fixed content elements and variable content elements. Fixed content elements may include inter alia images, graphics, and text fields that cannot be modified by the customer. Variable content elements may include images and text fields which can be modified by the customer. For example, in the case that a variable content element is an image, the customer can select an image from their own store of images and upload it. As another example, if a variable content element is a text field then typically the print order system enables the customer to enter text in the field.

Further, each printable page may include a background design which is a content element that may be either fixed or variable and a page layout that describes positioning of each content element. Further a content element may be non-printable, for example a sound or video clip. Finally, the elements on each page have an order, henceforth referred to as a “sequence”. Sequence is necessary to define the order to position or lay out elements on the page. For example, when two elements overlap, the printed result will typically be different depending on which element is placed on top. Further, elements may be partially transparent.

In another embodiment, a template may define only a single page or a subset of pages of a print product; for example, a template might define only the front page of a greeting card. In this embodiment, a customer may create a complete product by selecting one or more templates.

Typically a template defines the overall style of a print product. For example the template may define inter alia the size of the document, the type of paper, the front and back cover, a background image or graphic to be used on each page. Additionally, multi-page document, e.g. a calendar or photo book, may have page layouts for each page or for a group of pages that define visual elements for a single page or for a group of pages.

Some of the templates provided by the print order system may be supplied by independent designers using the present invention. Other templates may be provided by designers that either work on the staff of or are contracted by the print order system operator. Such templates may be provided to the print operating system by means outside the scope of the present invention.

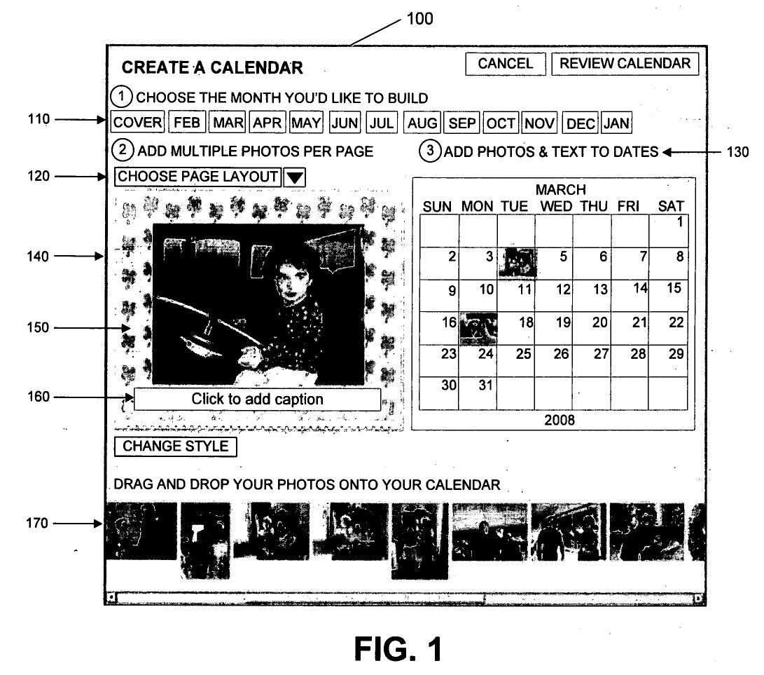

Reference is now made to FIG. 1, an exemplary customer interface 100 used by a customer to create a calendar, in accordance with an embodiment of the subject invention. Exemplary customer interface 100 is displayed after a customer visits a print order web site and selects a calendar template to customize. Exemplary customer interface 100 enables a user to interactively customize two calendar pages in accordance with a user-selected template. Exemplary customer interface 100 includes two pages for the month of March 2008: on the left of the screen is a single, large, user-supplied photo; and the right side of the screen shows a graphical layout for the month of March, which includes two small customer-supplied photos. The customer customizes the calendar pages by supplying his/her own images and/or text.

A month control 110 enables the customer to select the month he/she wishes to customize, or to select the cover page to customize. The customer can change the default page layout using a pull-down menu 120. Pull-down menu 120 displays a list of alternative page layouts for the page facing the actual calendar. In one embodiment the customer can select layouts that include one, two, three or four images. The customer can add text and/or photos to an individual day 130. The customer-selected calendar template includes a background design 140. In this example, the customer has selected a page layout with a single image. The customer drags an image from a gallery 170 of his/her photos and drops the image a the rectangular area 150 in which it is displayed. The customer may enter a caption 160 below the image. The attributes of the caption text, which include inter alia font, style, and size, are determined by the template. In one embodiment, the template determines the initial caption text attributes and the customer may subsequently modify the caption text attributes.

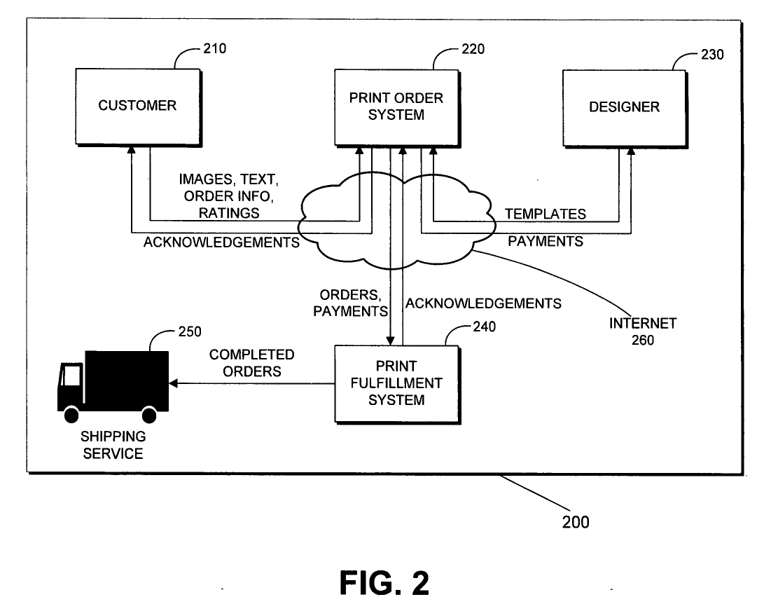

Reference is now made to FIG. 2 which is a simplified block diagram of a system that accepts templates from designers, enables customers to create custom print products using said templates and purchase the custom print products, generate orders and provide said order to a print fulfillment system that fulfills the orders, in accordance with an embodiment of the subject invention. A customer 210 uses a personal computer, wireless device, or other means to interact with a print order system 220 with the objective of creating and purchasing one or more custom print products. Customer 210 selects the type of print product, e.g. calendar or photo book, and further selects a template. Customer 210 customizes the template by supplying inter alia images and text. When customer 210 has interactively created a custom print product he/she provides contact and payment information, e.g. credit or debit card information.

Print order system 220 is typically a web site or retail store. In the case of a retail store a computer-based kiosk may be used to provide the print order system 220 functions. Print order system 220 enables customer 210 to create and purchase custom print products. Print order system 220 further enables a designer 230 to provide templates that it in turn makes available for use by customer 220 to create and purchase custom print products. Print order system 220 generates orders to one or more print fulfillment systems 240 which create the custom print products purchased by customer 210. Typically, print order system 220 provides acknowledgements to customer 210 at various steps to inter alia confirm a purchase, and to indicate that his/her order has been printed or shipped. Acknowledgements are typically provided by email but may also be provided by file transfer protocol, or simple object access protocol (SOAP) message.

In the embodiment in which print order system 220 is a web site, customer 210, designer 230 and print fulfillment system 240 all communicate with print order system 220 across the public Internet 240.

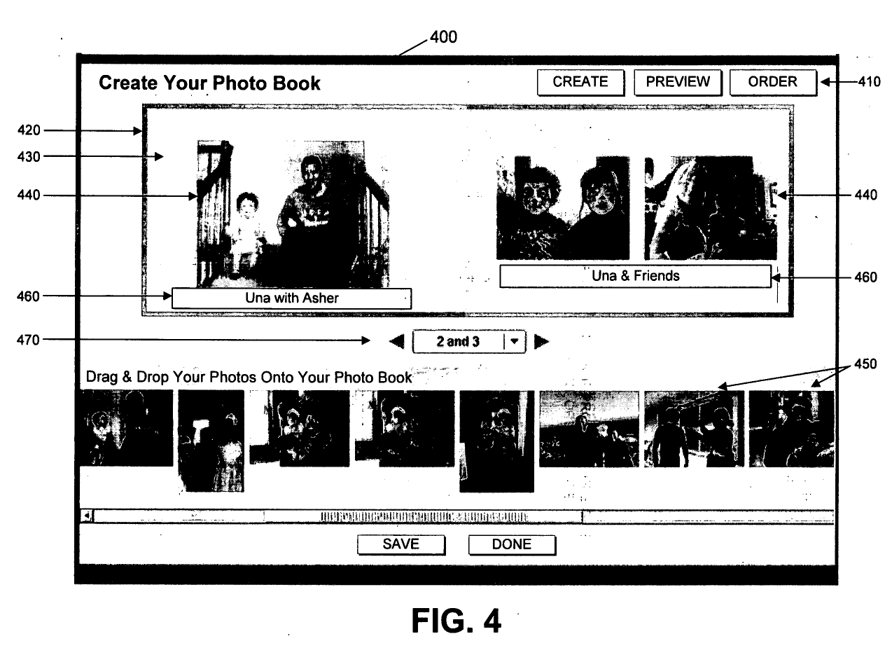

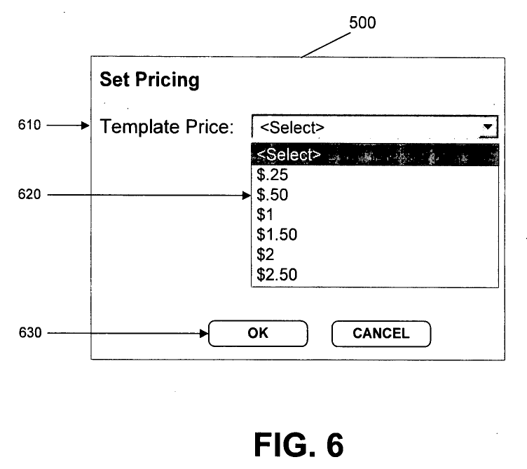

Designer 230 creates one or more templates for print products and provides them to print order system 220. In preparing a template, designer 230 follows rules defined by print order system 220. The rules specify inter alia the file formats, sizes and method by which to provide the template(s). One method that enables designer 230 to provide a template to print order system 220 is described with reference to FIG. 4. Another method that enables designer 230 to interactively specify a template is described with reference to FIG. 6.

Print fulfillment system 240 accepts orders from print order system 220 and creates the print products specified in the orders. Print fulfillment system 240 performs inter alia prepress processing, printing, binding, and packaging. After print products are created they are shipped. Typically, print fulfillment system 240 contacts a shipping service 250 which picks up the print products from print fulfillment system 240 premises and delivers them to the recipient(s). Typically, print fulfillment system 240 provides acknowledgements to print order system 220 at various states in the fulfillment process. Acknowledgements are typically provided by email by may also be provided by file transfer protocol, or simple object access protocol (SOAP) message. Typically, print fulfillment system 240 provides an acknowledgement to print order system 220 when an order is inter alia received, verified, accepted, printed or shipped.

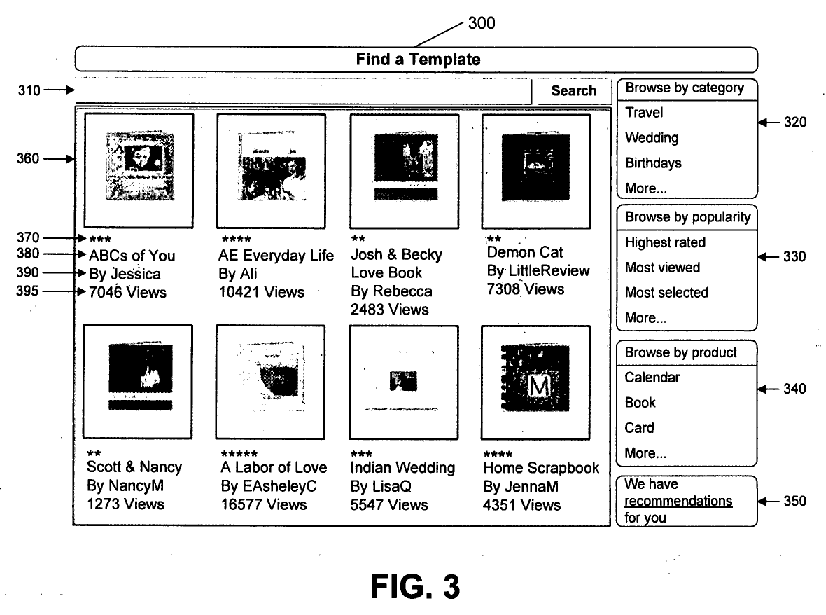

Reference is now made to FIG. 3 which is an exemplary customer interface 300 that illustrates how a customer 210 may browse and search for, rate and select a template for use in creating a custom print product, in accordance with an embodiment of the subject invention. Customer 210 may search for a template using search box 310 by entering one or more search terms into search box 310 and then clicking on a “Search” control. Alternatively, customer 210 may browse templates by category, measure of popularity or type of product. A list of categories 320 enables customer 210 to browse the available templates by category by selecting one of the categories or by selecting “Other” to see an expanded list of categories. A list of measures of popularity 330 enables customer 210 to browse the available templates by measures of popularity by selecting one of the listed measures of popularity or by selecting “Other” to see an expanded list of measures of popularity. A list of types of products 340 enables customer 210 to browse the available templates by the various types of products by selecting one of the listed types of products or by selecting “Other” to see an expanded list of types of products.

In addition, customer 210 may browse recommendations which are templates that print order system 220 has determined may be of interest to customer 210. A recommendations control 350 enables customer 210 to browse recommended templates.

A main window 360 presents templates that correspond to the search or browsing commands issued by customer 210. Each template depicted in main window 360 includes a customer rating 370, a title 380, a template designer name 390, and the number of customer views 395 for the template. In this example, customer ratings are in the form of a one to five star rating. Customer 210 may click on a star to rate the template.

Reference is now made to FIG. 4 which is an exemplary customer interface 400 that illustrates how a customer 210 may use a template provided by a designer to create a photo book, in accordance with an embodiment of the subject invention. Exemplary customer interface 400, which appears after customer 210 selects a designer-supplied template, enables customer 210 to create a photo book. A control 410 further enables customer 210 to preview the photo book in its current state and to order the photo book.

The designer-supplied template appears in a rectangular window 420 that presents two pages of the photo book. Customer 210 creates a custom print product by customizing the template. In this example, customer 210 customizes the template by selecting his/her own images and entering his/her own text. The customer may select one of his/her photos from a gallery of customer photos 450 and drag it into any of the rectangular photo boxes 440. This has the effect of replacing the contents of the rectangular photo box with the selected image. Additionally, the customer may edit the text that appears in any of the text boxes 460. A page control 470 enables customer 210 to move forward and backward through the photo book, and to select a specific pair of pages to customize from a list of pages.

In the template shown in exemplary customer interface 400, designer 230 specifies the background design of each page, the page layout, the location of the photos and text and the text attributes.

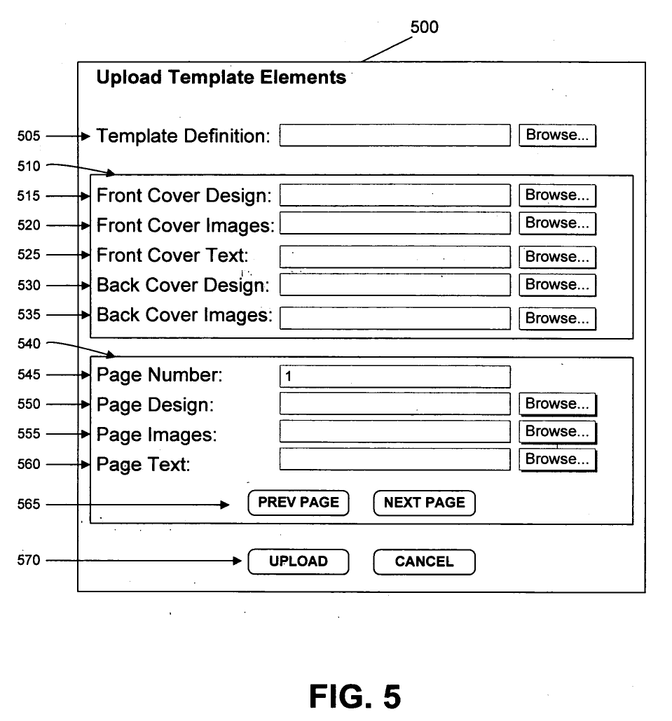

Reference is now made to FIG. 5 which is an exemplary customer interface 500 used by a designer to upload the elements for a template, in accordance with an embodiment of the subject invention. Exemplary customer interface 500 enables designer 230 to specify all the elements that comprise a template for a single product and to upload those elements to print order system 220. It should be noted that the terms “customizable image” and “customizable text field” are used hereinafter to refer to variable content elements that are images and text fields respectively.

The first entry field is a template definition field 505 which enables designer 230 to provide the filename of a template definition file. Designer 230 may enter the name of a template definition file or may browse their computer and select a template definition file. A template definition file includes attributes that define the template including font and position information. In addition, the template definition file allows the designer to enter search terms, or “tags”. An example of the attributes included in a template definition file are included in Table 1 below:

TABLE 1
Template Definition File Attributes

| Attribute Name | Data Type | Description |
|---|---|---|
| Template_Name | Alphanumeric | Name of the template; used for |
| | | indexing and also display |
| | | purposes. If a new template name |
| | | is provided, then a new template |
| | | will be created. If an existing |
| | | template name is provided then |
| | | the existing template will be |
| | | modified by the supplied |
| | | information. |
| Product_Type | Alphanumeric | Name of the product type to be |
| | | created using this template, e.g. |
| | | calendar or photo book. |
| | | Product_Type must be a single |
| | | name selected from an approved |
| | | list of product types. |
| Tags | Alphanumeric | List of search terms, separated by |
| | list | commas or semi-colons. |
| Number_of_pages | Numeric | Number of pages in length |
| | | excluding cover page and back |
| | | cover page. |
| Page_Size | Alphanumeric | An approved page size for the |
| | | applicable product type, e.g. |
| | | Portrait Letter, Landscape Letter, |
| | | Portrait A4, Landscape A4 |
| Front_cover_style | Alphanumeric | The style for the cover, e.g. die |
| | | cut, standard. |
| Front_cover_num_images | Numeric | Number of customizable images on |
| | | the front cover |
| Front_cover_image1_pos_size | Numeric, | The position of the first |
| | Numeric, | customizable image on the front |
| | Numeric, | cover, typically defined as X, Y |
| | Numeric | coordinates in pixels and the size, |
| | | defined as width, height in pixels. |
| | | This field is repeated for each |
| | | customizable image on the front |
| | | cover. |
| Front_cover_num_text | Numeric | Number of customizable text fields |
| | | on the front cover |
| Front_cover_text1_pos_size | Numeric, | The position of the first |
| | Numeric, | customizable text field on the front |
| | Numeric, | cover and the size, typically |
| | Numeric | defined as X, Y coordinates in |
| | | pixels and the size, defined as |
| | | width, height in pixels. This field is |
| | | repeated for each customizable |
| | | text field on the page. |
| Front_cover_text1_font | Alphanumeric | Initial font attributes to be used for |
| | list | front cover text fields. Attributes |
| | | include inter alia font name, font |
| | | size, font style. |
| Back_cover_style | Alphanumeric | The style for the back, e.g. die cut, |
| | | standard. |
| Back_cover_num_images | Numeric | Number of customizable images on |
| | | the back cover |
| Back_cover_image1_pos_size | Numeric, | The position of the first |
| | Numeric, | customiable image on the front |
| | Numeric, | cover, typically defined as X, Y |
| | Numeric | coordinates in pixels and the size, |
| | | defined as width, height in pixels. |
| | | This field is repeated for each |
| | | image on the back cover. |
| Page_style | Alphanumeric | The style for an interior page, e.g. |
| | | glossy or matte, thickness, velum |
| | | separator. |
| Page1_num_images | Numeric | Number of customizable images on |
| | | the page. This field is repeated for |
| | | each page in the product. |
| Page1_image1_pos_size | Numeric, | The position of the first |
| | Numeric | customizable image on the page, |
| | | typically defined as X, Y |
| | | coordinates in pixels and the size, |
| | | defined as width, height in pixels. |
| | | This field is repeated for each |
| | | customizable image on the page. |
| Page1_num_text | Numeric | Number of customizable text fields |
| | | on the page. |
| Page1_text1_pos_size | Numeric, | The position of the first |
| | Numeric, | customizable text field on the page |
| | Numeric, | and the size, typically defined as |
| | Numeric | X, Y coordinates in pixels and the |
| | | size, defined as width, height in |
| | | pixels. This field is repeated for |
| | | each customizable image on the |
| | | page. |
| Page1_text1_font | Alphanumeric | Initial font attributes to be used for |
| | list | caption text (Font name, Font size, |
| | | Font style) |

A group of entry fields 510 enable designer 230 to specify elements for the front and back cover. It should be noted that not all print products, e.g. a note pad, have a front and back cover so designer 230 may leave some or all of fields in group of entry fields 510 empty. Group of entry fields 510 includes a front cover design field 415, a front cover images field 520, a front cover text field 525, a back cover design field 530, and a back cover images field 535. For each field, designer 230 may enter a filename or use the browse control to select a file. Front cover design field 515 enables designer 230 to specify an image which appears on the front cover of the printed product. In general, image files are in JPEG, BMP or another standard file format. Front cover images field 520 enables designer 230 to specify one or more images that will appear on the front cover. Optionally, designer 230 may leave front cover images field 520 empty in which case the corresponding image boxes specified in the template definition file may appear blank when they are first presented to customer 210. In the case of fields such as front cover images field 520 that allow for multiple filenames designer 230 may enter multiple filenames, separating each with a comma or semi-colon or may browse and select multiple files using a conventional browse box such as the browse boxes typically used by Microsoft Windows programs.

As an example, if the attribute Front_Cover_Num_images is set to two in the template definition file, then designer 230 may provide zero, or two files in font cover images field 520. If zero images are provided, then when print order system 220 displays the template the cover design will show two empty boxes, and customer 210 may supply two images, one for each box. If two images are supplied then the first will appear in the image boxes defined by the attribute Front_cover_image1_pos_size in the template definition file and the second will appear in the image box defined by the attribute Front_cover_image2_pos_size in the template definition file.

Front cover text field 525 enables designer 230 to specify one or more text fields that appear on the front cover. Optionally, designer 230 may leave front cover text field 520 empty in which case the corresponding text boxes specified in the template definition file may appear blank when they are first presented to customer 210.

Back cover design field 530 enables designer 230 to specify an image to appear on the back cover of the printed product. Back cover images field 535 enables designer 230 to specify one or more images that will appear on the back cover. Optionally, designer 230 may leave back cover images field 535 empty in which case the corresponding image boxes specified in the template definition file may appear blank when they are first presented to customer 210. In this embodiment, no provision is made for text fields on the back cover. In another embodiment, text fields may be added to the back cover.

A group of entry fields 540 enable designer 230 to specify elements for each of the interior pages in a custom print product. It should be noted that not all print products, e.g. a post card, have interior pages, so designer 230 may leave some or all of fields in group of entry fields 540 empty. Group of entry fields 54 includes a page number field 545, a page design field 550, a page images field 555, a page text field 560, and a page control 565.

Page number field 545 enables designer 230 to specify which page number they are specifying. Page design field 550 enables designer 230 to specify a page design which is an image file, typically in JPEG, BMP or another standard file format, which appears on page being specified. Page images field 555 enables designer 230 to specify one or more images that will appear on the page being specified. Optionally, designer 230 may leave page images field 555 empty in which case the corresponding image boxes specified in the template definition file may appear blank when they are first presented to customer 210. Page text field 560 enables designer 230 to specify one or more text fields that will appear on the page being specified. Optionally, designer 230 may leave page text field 560 empty in which case the corresponding text boxes specified in the template definition file may appear blank when they are first presented to customer 210.

When designer 230 finishes specifying the various entry fields in group of entry fields 540 he/she uses page control 565 to move to the previous page or the next page. When the previous page is selected then the value in page number field 545 decrements by one and the information previously entered into page design field 550, page images field 555, and page text field 560 is displayed. If no information was previously entered into said fields then they will appear blank. If designer 230 selects the next page then the value in Page Number field 545 increments by one and the information previously entered into page design field 550, page images field 555, and page text field 560 is displayed. If no information was previously entered into said fields then they appear blank.

A control 570 enables designer 230 to either upload all specified information to print order system 220 or to cancel the specification process and return to a previous screen.

Although sequence information is not explicitly provided in the template definition file, simple rules may be applied to guide the formatting of the resulting print product. For example, when two or more images overlap, the images can be laid out in the order in which they appear in the template definition file. Further, if a text field overlaps an image field then the text field will appear on top.

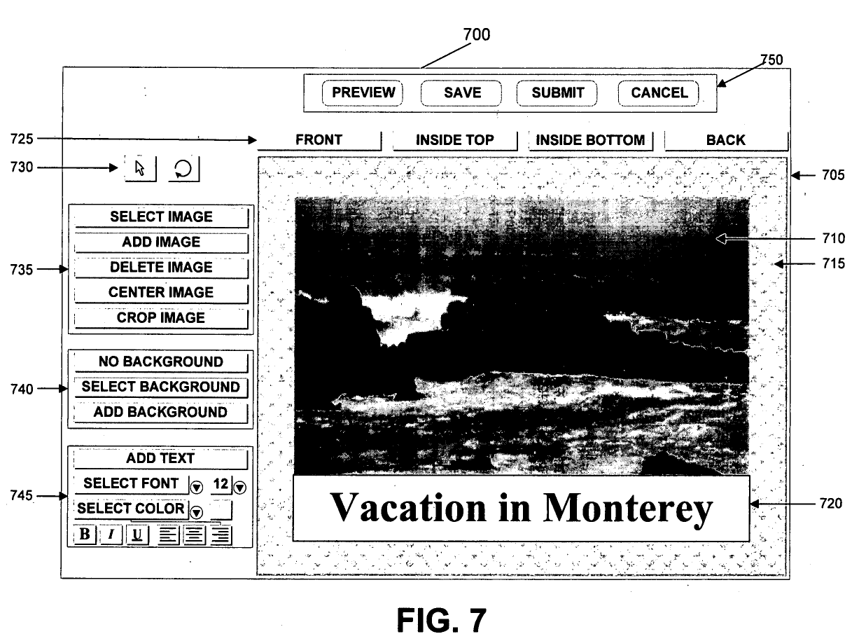

It will be appreciated by those skilled in the art that the approach described with reference to FIG. 5, uploading a template definition file together with each of the individual design, image and text elements, is one of many possible methods for enabling a designer to specify a template. Another method is described with reference to FIG. 7. A template definition file may be formatted inter alia using the hypertext markup language (HTML), extensible markup language (XML), or comma separated values (CSV). Furthermore, in another embodiment, a web service may be used in which all elements are communicated between print order system 220 and designer 230 using XML files and SOAP messages.

Reference is now made to FIG. 6 which is an exemplary designer interface used by a designer to select the price of a template, in accordance with an embodiment of the subject invention. Print order system 220 provides designer 230 with designer interface 600 that includes a template price selection menu 610, a list of prices 620 and a set pricing control 630. Template price selection menu 610 is used to select a price from list of prices 620. The price represents the amount that print order system will pay designer 230 each time a customer 210 creates and orders a print product that uses the template provided by designer 230. List of prices 620 is provided by print order system 220. Set pricing control 630 enables designer 230 to accept the price he/she has selected or to cancel the operation in which case no price selection is made.

It will be appreciated by those skilled in the art that the approach to pricing described with reference to FIG. 6, selecting a price from a list of prices provided by print order system 220, is one of many possible pricing models for establishing the compensation that will be paid to designer 230 for their template. Presented hereinafter are a few alternative example pricing models.
1. A designer provides an arbitrary price for a template, and may change his/her price from time to time.
2. The price selected or provided by the designer for a template is used as an initial published price. Subsequently, print order system 220 dynamically adjusts the price based on some or all of the following factors: selections of templates by customers, sales of print products that use a template, customer ratings of the template, and the number of times the template is viewed.
3. The price selected or provided by the designer for a template is used as an initial price. Print order system 220 periodically informs the designer of the success of the template in terms of sales and its performance relative to comparable templates. In one alternative, print order system proposes a new price or range of prices and the designer can adjust the price of the template accordingly.

Reference is now made to FIG. 7 which is an exemplary designer interface 700 used by a designer to interactively design a template, in accordance with an embodiment of the subject invention. Exemplary designer interface 700 is a client-server application in which designer 230 uses a client device such as a personal computer to interactively design a template which will subsequently be provided by print order system 220 to customer 210. Said client application may take the form of inter alia a web-based application that runs in a web browser such as Microsoft Internet Explorer or Mozilla Firefox, an independent application running in the Windows operating system, or a lava applet.

Exemplary designer interface 700 features a main window 705 that includes zero or more images 710, an optional background image 715 and zero or more text fields 720. The tools on the left side of main window 705 enable designer 230 to design a print product one page at a time. Using a set of page controls 725, designer 230 selects which page of the print product they want to design or edit. In the example shown in FIG. 7, the front page of a greeting card is being designed.

Two global tools 730 a pointer tool and a rotate tool, enable designer 230 to select, resize, delete, move and rotate an object. In this context, the term “object” refers to any of the selectable items that may appear in main window 705 including images, a background image and text fields. If designer 230 uses the pointer tool to select a text field he/she may enter or edit text in the field.

A group of image tools 735 enable designer 230 to select an image from a list of images and add it to the current page displayed in main window 705, add one or more of his/her own images to the list of images available for selection, delete one or more images from the current page displayed in main window 705, center one or more images in the current page displayed in main window 705, and crop an image in the current page displayed in main window 705.

A group of background tools 740 enables designer 230 to turn off a background image, select a background image from a list of background images and make it the new background image for the current page displayed in main window 705, and add one or more of his/her own images to the list of background images available for selection.

A group of text tools 745 enables designer 230 to add a text field to the current page displayed in main window 705, select the font for a text field, set the size of the font for a text field, select the color of the text in a text field, and edit the style of the text including inter alia bold, italic, underline, left justified, center justified and right justified.

A group of document controls 750 enables designer 230 to preview the completed print product, save the print product, submit the print product to print order system 220 and cancel making the current print product.

When designer 230 uses control 750 to submit the print product all elements that have been added are uploaded as necessary to print order system 220. In one embodiment, print order system 220 validates the template to ensure that it is complete and correctly specified. After pricing for the template has been established, as described with reference to FIG. 6 the template can be made available for searching, browsing and selection by customer 210.

In one embodiment, submitted templates are reviewed by human reviewers that perform additional review functions. For example, a reviewer may determine if the template contains any unsuitable material, or may apply an initial rating to the template.

Templates created by designer 230 and made available by print order system 220 are used by customer 210 to create custom print products. Typically, after creating one or more custom print products, customer 210 places an order for the products with print order system 220. For purposes of clarity, an order includes one or more copies of one or more products offered for sale by print order system 220. An order may include custom print products and other non-custom products for sale by print order system 220 such as scrapbook supplies. An order is equivalent to a shopping cart in an ecommerce system. Print order system 220 provides orders to print fulfillment system 250.

An order may include multiple line items where each line item designates a unique product to be printed. A line item, also known as a stock keeping unit (SKU) or a part, refers to a single product. Example line items include photo books, business cards, calendars, notepads, and greeting cards. A line item has attributes including inter alia a quantity and a number of pages. A line item with quantity greater than one, i.e., multiple copies of the same product, can be shipped to multiple recipients. For example, if four copies of a calendar are printed, three may be shipped to one recipient and one to a different recipient. A line item is composed of one or more “material parts.” For example, a photo book consists of a cover, a spine and book pages, referred to as “book block”. Each of the components (e.g. cover, spine, book block) of a line item or product is referred to as a “material part.” Some material parts are printed items, e.g. greetings cards and calendars; other material parts are non-printed items such as a velum separator page or a red cover.

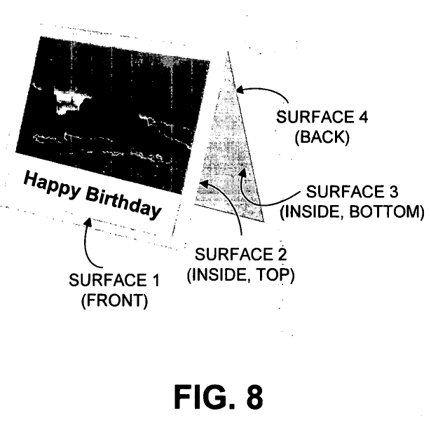

Reference is now made to FIG. 8 which is a depiction of a greeting card with four surfaces, in accordance with an embodiment of the subject invention. Generally, each product to be printed consists of one or more “surfaces” where a surface is defined as a printed side of a page. For example, a page in a photo book has two surfaces, front and back, while a greeting card has four surfaces. Thus the greeting card illustrated in FIG. 8 has four surfaces; namely, front, inside top, inside bottom, and back.

In one embodiment, one digital image, referred to as a “composite image” or “composite,” is created and stored by print order system 220 for each surface. The composite image exactly represents the surface to be printed. The use of composite images between print order system 220 and print fulfillment system 250 allows print fulfillment system 250 to provide WYSIWG (what you see is what you get) printing. In other words, the document that the customer sees on their display appears identically to the printed product that they receive from shipping service 250. In order to achieve WYSIWG printing, the composite is typically an image that covers the entire surface and is reproduced as precisely as possible by print fulfillment system 250.

Thus, print order system 220 “rasterizes” each page of the custom print product, where rasterizing refers to the process of processing the internal format used by print order system 220 to initially represent the custom print product to create a pixel image for each printed surface in the custom print product. In this embodiment, print fulfillment system 250 receives no information concerning the template used by customer 210 to create their printed product. Print fulfillment system 250 receives orders from print order system 220 in which each surface of each custom print product has been rasterized. All product formatting information, such as size, paper or media type is pre-defined for each unique line item.

An order is typically stored in a. database An order can be formatted inter alia using a text encoding such as CSV, in a coded binary format, in HTML format, or in XML format. In one embodiment, an order is represented by a single record in XML format with a schema that is commonly understood and therefore may be correctly processed by both print order system 220 and print fulfillment system 250.

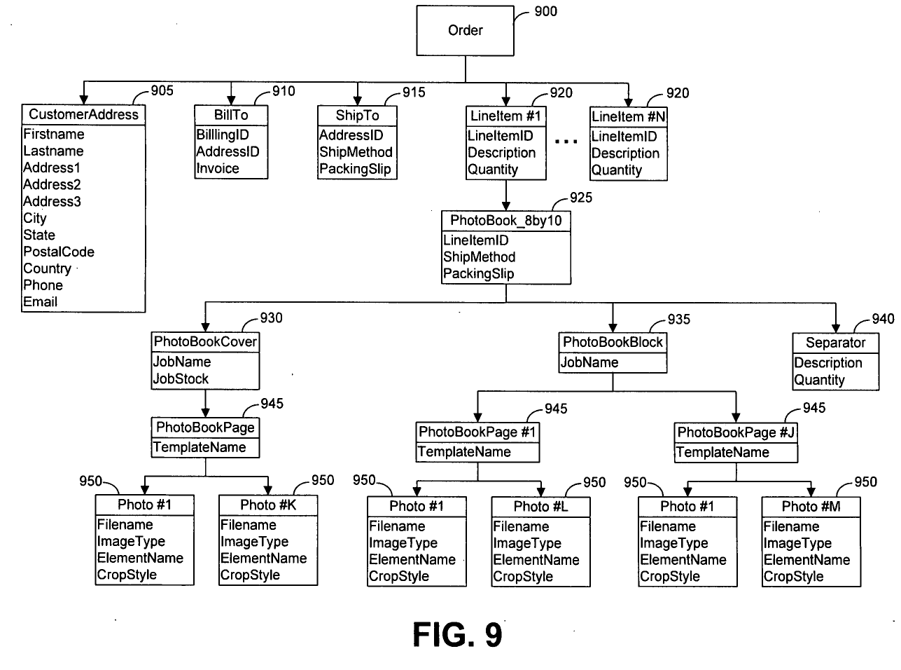

Reference is now made to FIG. 9, a schematic description of a simplified order of a photo book, in accordance with an embodiment of the subject invention. An order 900 includes CustomerAddress information 905, BillTo information 910, ShipTo information 915, one or more LineItems 920. It is noted that a LineItem is the name for a line item element and the LineItemID attribute in the LineItem element refers to a unique line item. The example depicts a single LineItem, an 8×10 inch photo book, referred to as PhotoBook_{—}8by10 925. PhotoBook_{—}8by10 925 includes a PhotoBookCover 930, a PhotoBookBlock 935, and a NonPrintableMaterial 940 which in the present example is a velum separator page between the cover and the first page of book block. PhotoBookCover 930 includes a single PhotoBookPage 945, which may contain one or more photo 950 elements. PhotoBookBlock 935 includes one or more PhotoBookPage 945 elements. Each PhotoBookPage 945 includes one or more photo 950 elements.

As previously discussed, each surface is provided by print order system 220 as a composite image that includes all required information to print one surface. In this embodiment, each PhotoBookPage 945 element includes a single photo 950 element whose filename attribute references a single composite image.

The XML code for a simplified, exemplary, order for a photo book that follows the schema depicted in FIG. 9 is provided in LISTING 1 at the end of this specification. The order includes a single line item, an 8by10 photo book. The 8by10 photo book includes a cover, 2 book block pages and a velum separator page.

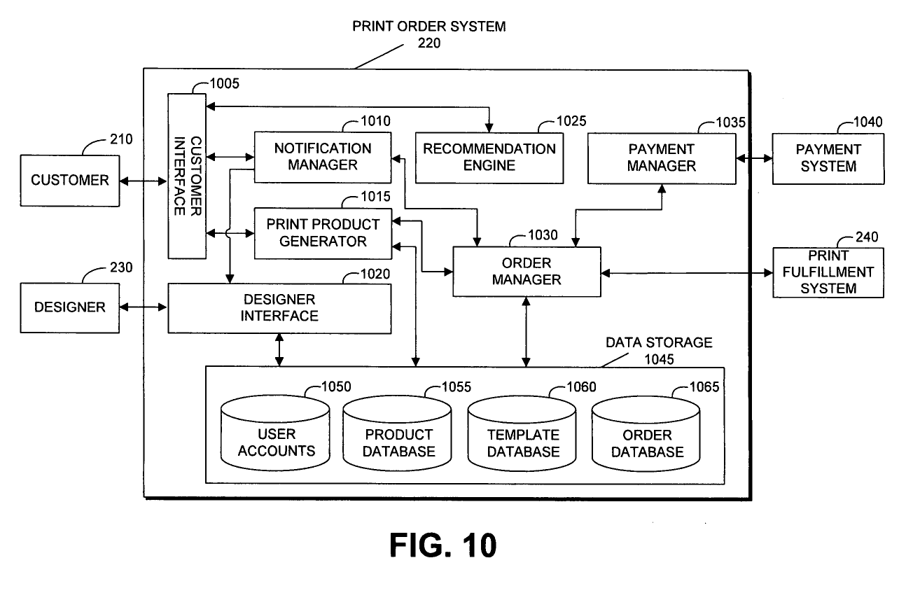

Reference is now made to FIG. 10 which is a simplified block diagram of a print order system, in accordance with an embodiment of the subject invention. Print order system 220 is typically implemented as one or more server computers. Thus, FIG. 10 may be regarded as a block diagram for a server computer system. Customer 210 interacts with print order system 220 via a customer interface 1005. Designer 230 interacts with print order system 220 via a designer interface 1020. Print order system 220 interacts with one or more payment systems 1040 via a payment manager 1035 and with print fulfillment system 250 via an order manager 1030.

A data storage 1045 stores a user accounts database 1050, a product database 1055, a template database 1060, and an order database 1065. Product database 1055 stores records for each line item, which can be created or selected for purchase by customer 210. Each record includes (i) a stock keeping unit (SKU) for the line item which uniquely identifies it, (ii) a description of the item which may include a thumbnail image of the item and a text description, (iii) a description of product options for the item, (iv) a price of the line item with and without the product options, (v) shipping information for the line item including shipping cost, and (vi) information about the print fulfillment system that provides the line item.

Data storage 1045 includes a relational database management system (RDBMS) and physical storage. In addition, data storage 1045 may include network attached storage (NAS), which is data storage that can be connected directly to a computer network to provide centralized data access and storage for other network devices. For example, NAS would enable multiple servers to directly store and share data.

Customer interface 1005 enables customer 210 to browse, search for and select print products from product database 1050, and to browse, search for, rate, and use templates from template database 1055. Customer interface 1005 further enables customer 210 to create custom print products. Additionally, customer interface 1005 enables customer 210 to view recommendations generated by recommendation engine 1025.

Customer interface 1005 may request that customer 210 sign in while interacting with customer interface 1005. Customer interface 1005 uses customer information stored in user accounts database 1045 as part of the sign-in process. If customer 210 is not a registered user, then customer interface 1005 enables the customer to register with print order system 220. In this case, customer interface 1005 creates a new record in user accounts database 1045 for the new customer. Customer interface 1005 is typically a web interface composed of HTML web pages. Said HTML web pages may be static web pages stored as HTML files or may be generated dynamically in response to customer 210 and designer 230 requests.

A print product generator 1015 enables customer 210 to interactively create custom print products via customer interface 1005. Print product generator 1015 adds a new line item to a shopping cart managed by order manager 1025 for each print product created by customer 210. Print product generator 1015 stores each print product in an internal print product format. In one embodiment, customer 210 uses a web browser to access customer interface 1005. In another embodiment, customer 210 uses an application, such as a Microsoft Windows application, that runs on their personal computer or other device to access customer interface 1005.

Designer interface 1020 enables designer 230 to upload templates that will be browsed, searched for, rated and used to create custom print products by customer 210. In one embodiment, designer interface 1020 enables designer 230 to interactively create templates. Designer interface 1020 adds a new template to template database 1055 for each template provided by designer 230. In one embodiment, designer 230 uses a web browser to interact with designer interface 1020. In another embodiment, the designer 230 uses a client application, such as a MS Windows application, that runs on their personal computer or other device to interact with designer interface 1020. Designer interface 1020 further enables designer 230 to delete and modify existing templates. In one embodiment, designer interface 1020 enables designer 230 to establish the price to be charged for the use of a template he/she creates.

Designer interface 1020 may request that designer 230 sign in while interacting with designer interface 1020. Designer interface 1020 uses designer information stored in user accounts database 1045 as part of the sign-in process. If designer 230 is not a registered user, then designer interface 1020 enables the designer to register with print order system 220. In this case, designer interface 1020 creates a new record in user accounts database 1045 for the new designer.

Recommendation engine 1025 uses historical customer information to make recommendations to customer 210 via customer interface 1005 regarding templates. Recommendations engine 1025 stores ratings information for each rating made by a customer 210 in template database 1060. Such ratings information may include the value of the rating and the name of the user that made the rating. Recommendations engine 1025 also stores information in template database 1060 about which template was used, if any, for each custom print product created and purchased and the name of the customer that created and purchased said custom print product. One method that may be used by recommendation engine 1025 to determine recommendations for a customer (“customer X” in the following example method) is as follows: (1) find a set of users whose rated templates and used (for creating products) templates overlap customer X's purchased and used templates; (2) aggregate templates from these similar customers, (3) eliminate templates that customer X has already used or rated, and recommend the remaining templates to the customer X. A variety of recommendation engine methods can be found in the literature.

Order manager 1030 transforms each print product, stored in an internal print product format, into (1) a line item record in order database 1060 and (2) a number of composite images, one for each surface in the print product or line item. To create a composite image, order manager rasterizes the customized data for each surface into a pixel image, i.e. one composite image per surface.

Order database 1065 further creates a record for each customer 210 order. Each record includes (i) a unique identifier for the order, referred to as an order identifier, (ii) the name of the customer, (iii) the date of the order, (iv) means of payment information, (v) the line items and quantities ordered, (vi) the name and contact information of each recipient, (vii) any special shipping information or message provided by customer 210.

A payment manager 1035 processes means of payment information provided by customer 210. Payment manager 1035 uses the means of payment information to obtain payment for orders placed by customer 210. If a payment or partial payment must be refunded, payment manager 1035 uses the means of payment information to make said refund. When payment for an order is complete, payment manager 1035 notifies order manager 1030. Payments that payment manager 1035 is typically capable of processing include credit card, debit card, and Pay Pal. It should be noted that a Pay Pal payment refers to a popular method of electronic payment offered by PayPal which is a company that was purchased and is owned by eBay Inc. Further information about PayPal can be obtained at www.paypal.com. After payment is successfully completed, the order is provided to print fulfillment system 240 for processing.

Payment manager 1035 also tracks use of templates provided by designer 230 and makes payments to designer 230 for the use of their templates. Payment is made using means of payment information supplied by designer 230 when he/she registers with print order system 220.

A notification manager 1010 runs as a background process in print order system 220. When notification manager 1010 detects that new information has been received relative to an order, e.g. an update from print fulfillment system 240 or a payment made to designer 230, it provides notification to the appropriate party, either customer 210 or designer 230. In one embodiment, notification manager 1010 issues notifications in the form of screen messages via customer interface 1005 or designer interface 1020 as appropriate. Alternatively notifications may be in the form of email acknowledgement messages. In one embodiment, the acknowledgement message is in XML format. In another embodiment, status information for each order is provided using a SOAP web service. The SOAP protocol is maintained by the World Wide Web Consortium (W3C) and the specification can be found at http://www.w3.org/TR/soap/.

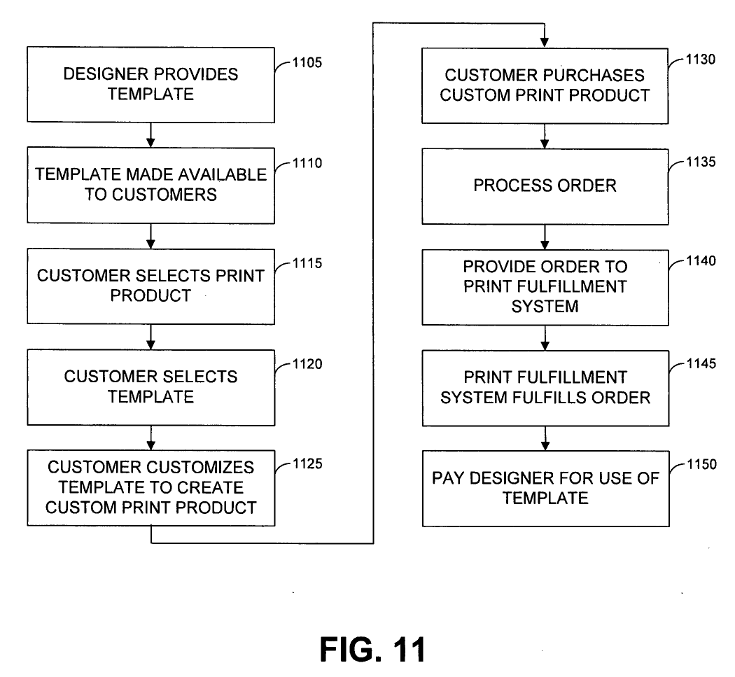

Reference is now made to FIG. 11, which is a simplified flowchart of an overall method that accepts templates from designers, enables customers to create custom print products using said templates and purchase the custom print products, generate orders and provide said orders to a print fulfillment system that fulfills the orders, in accordance with an embodiment of the present invention. At step 1105 designer 230 provides a template to print order system 220. At step 1110 print order system 220 makes the template available for searching, browsing and use by customer 210. At step 1115 customer 210 selects a print product that he/she wishes to create, for example a calendar, mug or photo book. Then, at step 1120 customer 210 selects a template that corresponds to the print product that he/she wishes to use to create a custom print product. At step 1125 customer 210 interacts with print order system 220 via customer interface 1005 to create a custom print product.

At step 1130 customer 210 purchases the custom print product by placing an order that includes the custom print product. Next, at step 1135 print order system 220 processes the order into a format that can be processed by print fulfillment system 240. At step 1140 print order system 220 provides the order to print fulfillment system 240 for fulfillment. At step 1145 print fulfillment system 240 fulfills the order. Finally, at step 1150 print order system 210 pays designer 230 for use of the template. Typically, said payment is made on a periodic basis and includes payment for a plurality of uses of templates created by designer 230.

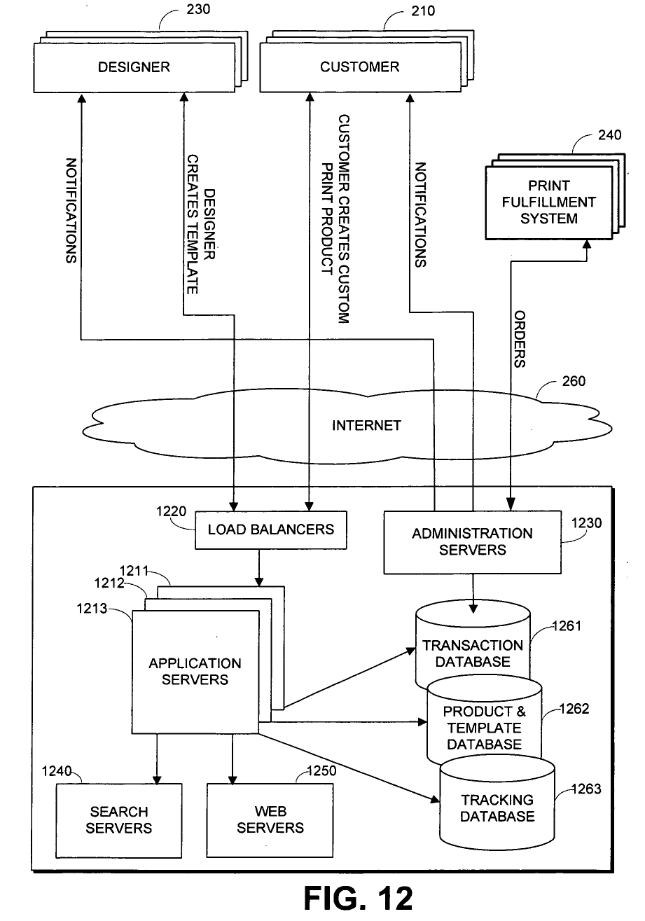

It will be appreciated by those skilled in the art that the systems and methods of the present invention may be implemented within a variety of server-client network architectures. In this regard, reference is now made to FIG. 12, which is a simplified block diagram of a sample server-client architecture for implementing a print order system, in accordance with an embodiment of the present invention. On the server side, the architecture in FIG. 12 includes application servers 1211-1213 managed by load balancers 1220, administration servers 1230, search servers 1240, web servers 1250, and three databases. The databases include a transaction database for recording purchase and payment information 1261, a product and template database 1262 for storing product and template information, including the data from including the data from product database 1050 in FIG. 10 and template database 1055 in FIG. 10, and a tracking database 1263 for tracking customer orders and customer information including user account database 1045 from FIG. 10. Application server 1211 manages transaction database 1261, application server 1212 manages product and template database 1262, application server 1213 manages tracking database 1263, search servers 1240, and web servers 1250. All of these server components are subsumed in print order system 220.

On the client side, the architecture in FIG. 12 includes customer 210 using a client computer, designer 230 using a client computer, and print fulfillment system 250. Print fulfillment system 250 has two-way connections with administration servers 1230. Customer 210 and designer 230 have one-way connections with administration servers 1230 and two way connections with load balancers 1220.

In reading the above description, persons skilled in the art will realize that there are many apparent variations that can be applied to the methods and systems described.

LISTING 1

```
<?xml version=“1.0” encoding=“ISO-8859-1”?>
<Order xmlns=“http://www.ipads.com/xml/iPads_Order”
xmlns:xsi=“http://www.w3.org/2001/XMLSchema-instance”
CustomerID=“Partner_Brand” EnvelopeID=“33809” OrderID=“33809”
orderDate=“2007-02-12”
xsi:schemaLocation=“http://www.ipads.com/xml/iPads_Order
iPads_Order.xsd”>
  <Address AddressID=“1”>
    <firstname>Mark</firstname>
    <lastname>Gustafson</lastname>
    <address1>100 EastLake Ave N</address1>
    <address2></address2>
    <address3></address3>
    <city>Seattle</city>
    <state>WA</state>
    <postalcode>98101</postalcode>
    <country>US</country>
    <phone></phone>
    <email>mark@rpiprint.com</email>
  </Address>
  <Contact ContactID=“1” AddressID=“1” />
  <BillTo BillingID=“1” AddressID=“1”> <Invoice /> </BillTo>
  <ShipTo AddressID=“1”>
    <ShipMethod>GROUND</ShipMethod>
    <PackingSlip include=“true” />
  </ShipTo>
  <LineItem LineItemID=“18751” description=“scenes” quantity=“7”>
    <PhotoBook_8by10wrap>
      <PhotoBookAttributes/>
        <PhotoBookCover>
          <PhotoBookCoverAttributes>
            <JobName Value=“CoverPortrait”/>
            <JobStockValue=
            “Black_Small_Wrap_Cover_Port_PartnerBrand”/>
          </PhotoBookCoverAttributes>
          <PhotoBookPage PartOrder=“1”>
            <PhotoBookPageAttributes>
              <TemplateName Value=“StandardWrapPortraitCover”/>
            </PhotoBookPageAttributes>
              <Photo>
                <PhotoAttributes>
                  <Filename Value=“cover_P24786_0002.pdf”/>
                  <ImageType Value=“pdf”/>
                  <ElementName Value=“Photo1”/>
                  <CropStyle Value=“StretchFit”/>
                </PhotoAttributes>
              </Photo>
            </PhotoBookPage>
        </PhotoBookCover>
        <PhotoBookBookBlock>
          <PhotoBookBookBlockAttributes>
            <JobName Value=“DuplexPortrait”/>
          </PhotoBookBookBlockAttributes>
          <PhotoBookPage PartOrder=“1”>
            <PhotoBookPageAttributes>
              <TemplateName Value=“StandardPortrait”/>
            </PhotoBookPageAttributes>
            <Photo>
              <PhotoAttributes>
                <Filename Value=“page_P24786_0001.pdf”/>
                <ImageType Value=“pdf”/>
                <ElementName Value=“Photo1”/>
                <CropStyle Value=“StretchFit”/>
              </PhotoAttributes>
            </Photo>
          </PhotoBookPage>
          <PhotoBookPage PartOrder=“2”>
            <PhotoBookPageAttributes>
              <TemplateName Value=“StandardPortrait”/>
            </PhotoBookPageAttributes>
            <Photo>
              <PhotoAttributes>
                <Filename Value=“page_P24786_0002.pdf”/>
                <ImageType Value=“pdf”/>
                <ElementName Value=“Photo1”/>
                <CropStyle Value=“StretchFit”/>
              </PhotoAttributes>
            </Photo>
          </PhotoBookPage>
        </PhotoBookBookBlock>
      <NonPrintableMaterial>
          <NonPrintableMaterialAttributes>
            <Description Value=“VelumSeparator012”/>
            <Quantity Value=“1”/>
          </NonPrintableMaterialAttributes>
      </NonPrintableMaterial>
    </PhotoBook_8by10wrap>
  </LineItem>
</Order>
```

What is claimed is:

1. A method for providing designer templates to a customer, comprising:
i) providing a designer interface for receiving a designer template for a print product from a designer wherein a designer template comprises fixed content elements and at least one variable content element; and
ii) providing a customer interface for:
enabling a customer to select a print product and to select a designer template for the selected print product;
enabling the customer to customize the selected print product by supplying his own content for the at least one variable content element of the selected designer template; and
enabling the customer to purchase the custom print product that he customized.

2. The method of claim 1 wherein said at least one variable content element includes at least one text field.

3. The method of claim 1 wherein said at least one variable content element includes at least one digital image.

4. The method of claim 1 wherein said receiving a designer template comprises receiving a template uploaded by a designer.

5. The method of claim 1 wherein said receiving a designer template comprises enabling the designer to interactively design a designer template.

6. The method of claim 1 wherein said customer interface further enables a customer to enter a rating for a designer template, and to view at least one statistic for a designer template, the method further comprising deriving statistics for designer templates by aggregating customer ratings entered via said customer interface.

7. The method of claim 1 wherein said customer interface further enables a customer to enter a rating for a designer template, and wherein said customer interface further presents at least one recommendation for designer templates to a customer, the method further comprising deriving recommendations for designer templates by aggregating customer ratings entered via said customer interface.

8. The method of claim 1 wherein said customer interface further presents at least one recommendation for designer templates to a customer, the method further comprising deriving recommendations for designer templates based on customer purchases of custom print products that use said designer templates.

9. The method of claim 1 wherein said customer interface enables a customer to select a print product prior to selecting a designer template.

10. The method of claim 1 wherein said customer interface enables a customer to select a designer template prior to selecting a print product.

11. A system for providing designer templates to a customer, comprising:
i) a designer interface for receiving a designer template for a print product from a designer wherein a designer template comprises fixed content elements and at least one variable content element; and
ii) a customer interface for:
enabling a customer to select a print product and to select a designer template for the selected print product;
enabling the customer to customize the selected print product by supplying his own content for the at least one variable content element of the selected designer template; and
enabling the customer to purchase the custom print product that he customized.

12. The system of claim 11 wherein said at least one variable content element includes at least one text field.

13. The system of claim 11 wherein said at least one variable content element includes at least one digital image.

14. The system of claim 11 wherein said receiving a designer template comprises receiving a template uploaded by a designer.

15. The system of claim 11 wherein said receiving a designer template comprises enabling the designer to interactively design a designer template.

16. The system of claim 11 wherein said customer interface further enables a customer to enter a rating for a designer template, and to view at least one statistic for a designer template, the system further comprising a recommendation engine that derives statistics for designer templates by aggregating customer ratings entered via said customer interface.

17. The system of claim 11 wherein said customer interface further enables a customer to enter a rating for a designer template, and wherein said customer interface further presents at least one recommendation for designer templates to a customer, the system further comprising a recommendation engine that derives recommendations for designer templates by aggregating customer ratings entered via said customer interface.

18. The system of claim 11 wherein said customer interface further presents at least one recommendation for designer templates to a customer, the system further comprising a recommendation engine that derives recommendations for designer templates based on customer purchases of custom print products that use said designer templates.

19. The system of claim 11 wherein said customer interface enables a customer to select a print product prior to selecting a designer template.

20. The system of claim 11 wherein said customer interface enables a customer to select a designer template prior to selecting a print product.

21. A computer-readable storage medium storing program code for causing a computing device:
i) to receive a designer template for a print product from a designer wherein a designer template comprises fixed content elements and at least one variable content element;
ii) to enable a customer to select a print product and to select a designer template for the selected print product;
iii) to enable the customer to customize the selected print product by supplying his own content for the at least one variable content element of the selected designer template; and
iv) to enable the customer to purchase the custom print product that he customized.

22. A method for providing templates to a customer, comprising:
i) providing a designer interface for receiving a designer template for a print product from a designer wherein a designer template comprises fixed content elements and at least one variable content element;
ii) providing a customer interface for:
enabling a customer to select a print product and to select a designer template for the selected print product;
enabling the customer to customize the selected print product by supplying his own content for the at least one variable content element of the selected designer template; and
enabling the customer to purchase the custom print product that he customized; and
(iii) providing an electronic payment, the amount of which is based on purchases by customers of print products that use a designer's designer templates, to an account designated by the designer.

23. The method of claim 22 wherein said amount is based on a price, selected by the designer from a list of prospective prices, that will be paid to the designer for each purchase by a customer of a custom print product that uses a designer template received from the designer.

24. The method of claim 22 wherein said amount is based on a price, proposed to the designer and accepted by the designer, which will be paid to the designer for each purchase by a customer of a custom print product that uses a designer template received from the designer.

25. The method of claim 22 wherein said amount is based on a price, specified by the designer, which will be paid to the designer for each purchase by a customer of a custom print product that uses a designer template received from the designer.

26. The method of claim 22 wherein said at least one variable content element includes at least one text field.

27. The method of claim 22 wherein said at least one variable content element includes at least one digital image.

28. The method of claim 22 wherein said receiving a designer template comprises receiving a template uploaded by a designer.

29. The method of claim 22 wherein said receiving a designer template comprises enabling the designer to interactively design a designer template.

30. The method of claim 22 wherein said customer interface further enables a customer to enter a rating for a designer template, and to view at least one statistic for a designer template, the method further comprising deriving statistics for designer templates by aggregating customer ratings entered via said customer interface.

31. The method of claim 22 wherein said customer interface further enables a customer to enter a rating for a designer template, and wherein said customer interface further presents at least one recommendation for designer templates to a customer, the method further comprising deriving recommendations for designer templates by aggregating customer ratings entered via said customer interface.

32. The method of claim 22 wherein said customer interface further presents at least one recommendation for designer templates to a customer, the method further comprising deriving recommendations for designer templates based on customer purchases of custom print products that use said designer templates.

33. The method of claim 22 wherein said customer interface enables a customer to select a print product prior to selecting a designer template.

34. The method of claim 22 wherein said customer interface enables a customer to select a designer template prior to selecting a print product.

35. A system for providing templates to a customer, comprising:
i) a designer interface for receiving a designer template for a print product from a designer wherein a designer template comprises fixed content elements and at least one variable content element;
ii) a customer interface for:
enabling a customer to select a print product and to select a designer template for the selected print product;
enabling the customer to customize the selected print product by supplying his own content for the at least one variable content element of the selected designer template; and
enabling the customer to purchase the custom print product that he customized; and
(iii) a payment manager for providing an electronic payment, the amount of which is based on purchases by customers of print products that use the designer's designer templates, to an account designated by the designer.

36. The system of claim 35 wherein said amount is based on a price, selected by the designer from a list of prospective prices, that will be paid to the designer for each purchase by a customer of a custom print product that uses a designer template received from the designer.

37. The system of claim 35 wherein said amount is based on a price, proposed to the designer and accepted by the designer, which will be paid to the designer for each purchase by a customer of a custom print product that uses a designer template received from the designer.

38. The system of claim 35 wherein said amount is based on a price, specified by the designer, which will be paid to the designer for each purchase by a customer of a custom print product that uses a designer template received from the designer.

39. The system of claim 35 wherein said at least one variable content element includes at least one text field.

40. The system of claim 35 wherein said at least one variable content element includes at least one digital image.

41. The system of claim 35 wherein said receiving a designer template comprises receiving a template uploaded by a designer.

42. The system of claim 35 wherein said receiving a designer template comprises enabling the designer to interactively design a designer template.

43. The system of claim 35 wherein said customer interface further enables a customer to enter a rating for a designer template, and to view at least one statistic for a designer template, the system further comprising a recommendation engine that derives statistics for designer templates by aggregating customer ratings entered via said customer interface.

44. The system of claim 35 wherein said customer interface further enables a customer to enter a rating for a designer template, and wherein said customer interface further presents at least one recommendation for designer templates to a customer, the system further comprising a recommendation engine that derives recommendations for designer templates by aggregating customer ratings entered via said customer interface.

45. The system of claim 35 wherein said customer interface further presents at least one recommendation for designer templates to a customer, the system further comprising a recommendation engine that derives recommendations for designer templates based on customer purchases of custom print products that use said designer templates.

46. The system of claim 35 wherein said customer interface enables a customer to select a print product prior to selecting a designer template.

47. The system of claim 35 wherein said customer interface enables a customer to select a designer template prior to selecting a print product.

48. A computer-readable storage medium storing program code for causing a computing device:
i) to receive a designer template for a print product from a designer wherein a designer template comprises fixed content elements and at least one variable content element;
ii) to enable a customer to select a print product and to select a designer template for the selected print product;
iii) to enable the customer to customize the selected print product by supplying his own content for the at least one variable content element of the selected designer template;
iv) to enable the customer to purchase the custom print product that he customized; and
v) to provide an electronic payment, the amount of which is based on purchases by customers of print products that use the designer's designer templates, to an account designated by the designer.
